(19) United States
(12) Patent Application Publication
(10) Pub. No.: US 2009/0281234 A1
(43) Pub. Date: Nov. 12, 2009

(54) MANUFACTURING METHOD OF THERMOPLASTIC COMPOSITE MATERIAL, THERMOPLASTIC COMPOSITE MATERIAL AND OPTICAL ELEMENT

(75) Inventor: Hiroaki Ando, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA OPTO, INC., Tokyo (JP)

(21) Appl. No.: 11/720,657

(22) PCT Filed: Nov. 11, 2005
(86) PCT No.: PCT/JP2005/021227

§ 371 Date: Jun. 1, 2007

(30) Foreign Application Priority Data
Dec. 10, 2004 (JP) 2004-358145

(51) Int. Cl. C08L 25/02; B01F 7/00

(52) U.S. Cl. 524/577; 366/69

(57) ABSTRACT

The present invention provides a transparent optical element having low thermal expansion and a manufacturing method of an optical element such as an object lens 15, the method having a melt-kneading process where a thermoplastic resin and an organic particle whose primary particles have a volume average dispersed particle size of not more than 30 nm, are melt-kneaded in an inert gas atmosphere.

### TECHNICAL FIELD

The present invention relates to a manufacturing method of a thermoplastic composite material superior in transparency of a blue ray, preferably used for a lens, a filter, a grating, a optical fiber and a flat plate optical waveguide and the thermoplastic composite material and an optical element manufactured by the method thereof.

### BACKGROUND

An optical pickup device is provided for a player, a recorder and a drive which read and record information on optical information recording media (hereinafter may simply called medium) such as MO, CD and DVD. The optical pickup device has an optical element unit which radiates a light beam having a predetermined wavelength from a light source on the medium and receives the reflected light beam by a light receiving element. The optical element unit has an optical element such as a lens which focuses the light beams on a reflecting layer of the medium or the light receiving element.

For the optical element of the optical pickup device, plastic materials are preferred to be used, because they can be manufactured economically by a method such as injection molding. As a plastic capable of the optical element, copolymers such as cyclic olefin and α-olefin are known.

Meanwhile, for example, in case of an information device capable of recording on a plurality of kinds of media, the optical pickup is required a configuration to cope with differences between the wavelength of the lights to be used and shapes of media. In such a circumstance, an optical element unit mutually used for every media is preferred from aspects of cost and characteristics of the pickup.

On the other hand, for the optical element unit utilizing plastic material, a material having optical stability of a glass lens is being required. For example, an optical plastic material such as cyclic olefin has substantially improved a stability of a refraction factor for humidity whereas improvement of a stability of the refraction factor for temperature is not yet sufficient at this stage.

As a method to correct the optical refraction factor of the plastic lens in the above, various methods using a microscopic particle filling material are suggested.

The microscopic particle filling material is used to correct the refraction factor of the optical plastic. Using a filling material whose particle size is sufficiently small, the plastic filled with the filling material has a sufficient transparency as the lens without causing light scattering. For example, technologies of filling the microscopic particles so as to increase the refraction factor of the plastic are disclosed in non patent document 1 and non patent document 2.

Also, for a purpose of improving the refraction factor and its temperature dependency, for example, there is suggested an optical product wherein the microscopic particle material is dispersed into a polymer host substance having a temperature sensitivity by kneading through a double-screw extruder so as to improve the temperature dependency of the refraction coefficient (for example, refer to patent document 1). Also, there is suggested an optical products wherein the microscopic particle material is dispersed into resins such as polystyrene, ethyl methacrylate, cyclic olefin or polysulphone by kneading through a double-screw extrudes so as to improve the temperature dependency of the refraction coefficient (for example refer to Patent Documents 2 to 5).

Further, in recent years, the optical pickups using a blue ray having the wavelength of not more than 500 nm are increasing. In case the wavelength of 400 nm is particularly used, the optical transparency of the plastic lens comes to an issue. Also, deterioration of the plastic and increase of temperature by absorbing light beam becomes obvious.

[Non Patent Document 1] C. Becker, P. Muller and H. Schmidt, [Study of optical and thermal dynamics in thermoplastic micro synthetic material having a surface modified by silica micro particle], SPIE Proceedings, 1998, July, Vol. 3468, Page 88-89.

[Non Patent Document 2] B. Braume, P. Muller and H. Schmidt, [Tantalum Oxide Nanomers for optical application], SPIE Proceedings, 1998, July, Vol. 3469. Page 124 to 132.

[Patent document 1] Unexamined Japanese Patent Application Publication No. 2002-207101

[Patent document 2] Unexamined Japanese Patent Application Publication No. 2002-241560

[Patent document 3] Unexamined Japanese Patent Application Publication No. 2002-241569

[Patent document 4] Unexamined Japanese Patent Application Publication No. 2002-241592

[Patent document 5] Unexamined Japanese Patent Application Publication No. 2002-241612

### DISCLOSURE OF THE INVENTION

### A Problem to be Solved by the Invention

In a composite material including the resin and the microscopic particle material, there is a problem that the optical transparency of an optical product produced for the blue ray having the wavelength of not more than 500 nm is likely to be deteriorated depending on conditions of kneading however, in the suggested methods in the above, there is no stipulation or indication at all as to practical kneading condition of the microscopic particle material and resin in respect to the above issue and there is no guide to realize the optical product having high optical transparency. At this stage, the kneading condition is determined through cut and try. Also, no guides are indicated for a suppression effect in respect to thermal expansion and a producing process of the composite material.

The invention has been achieved in view of the above problems, and an object of the present invention is to provide a manufacturing method of a thermoplastic composite material having high optical transparency and less thermal expansion preferably used for a lens, a filter, a grating, a optical fiber and a flat plate optical waveguide, and a thermoplastic composite material produced by the method thereof and an optical element.

### Means to Solve the Problem

In order to achieve the objects described above, this invention is made up of the structures below:

(1) A manufacturing method of a thermoplastic composite material having a melt-kneading process wherein a thermoplastic resin and an inorganic particle whose primary particle has a volume based average dispersed particle size of not more than 30 nm are melt-kneaded, wherein the melt-kneading process is carried out under an atmosphere of an inert gas.
(2) In the manufacturing method of the thermoplastic composite material of (1), the inert gas is a mixture of at least more than two kids of gases which are chosen among nitrogen, helium, neon, argon, krypton and xenon.
(3) In the manufacturing method of the thermoplastic composite material of (1) or (2), a content rate of the inorganic particle is more than or equal to 10% by weight and less than or equal to 80% by weight.
(4) In the manufacturing method of the thermoplastic composite material of (1), (2) or (3), the thermoplastic resin composite material includes at least cycloolefin resin.
(5) A thermoplastic composite material manufactured by any one of the manufacturing method of the thermoplastic composite material in (1), (2), (3) or (4).
(6) An optical element configured by the thermoplastic composite material of (5).
(7) A thermoplastic composite material including a thermoplastic resin and inorganic particle whose primary particle has a volume-based average dispersed particle size of not more than 30 nm, wherein an optical transparency is not less than 70% at 405 nm in a thickness of 3 mm.
(8) An optical element configured with the thermoplastic composite material of (7).

### EFFECT OF THE INVENTION

According to the present invention, a manufacturing method of a thermoplastic composite material superior in transparency of a blue ray, preferably used for a lens, and whose a thermal expansion is suppressed, as well as the thermoplastic composite material and the optical element produced by the method thereof can be provided.

### BRIEF DESCRIPTION OF THE DRAWINGS

FIG. 1 shows an outline of a structure of optical pickup device 1.

### DESCRIPTION OF SYMBOLS

1: Optical pickup device
15: Object lens (optical element)
SH1: Shaver (optical element)
BS1-BS5: Splitter (optical elements)
CL: Collimater (Optical element)
L11, L21, L31: Cylindrical lens (optical elements)
L12, L22, L32: Concave lens (optical elements)

### DETAILED DESCRIPTION OF THE PREFERRED EMBODIMENT

A embodiment of the present invention is described with reference to the drawings as follow: The embodiment described below include various restrictions which is preferred in a technical point of view, however a scope of the invention is not limited to the embodiment and drawings.

Firstly, a manufacturing method of the thermoplastic composite material related to the present invention is described.

The manufacturing method of a thermoplastic composite material related to the present invention has a melt-kneading process wherein a thermoplastic resin and an inorganic particle whose primary particle has a volume-based average dispersed particle size of not more than 30 nm are melt-kneaded, and the melt-kneading process is carried out in an atmosphere of an inert gas.

According the manufacturing method of the thermoplastic composite material, a thermoplastic composite material superior in transparency of a blue ray, and preferably used for a lens, filter, grating, optical fiber and flat plate optical waveguide, can be produced. Also, by forming the thermoplastic composite material in arbitrary sizes, the optical element related to the present invention can be produced.

Therefore, in manufacturing of the thermoplastic composite material having the thermoplastic resin and the inorganic particle whose primary particle has a volume-based average dispersed particle size of not more than 30 nm, by carrying out the melt-kneading process in an inert gas atmosphere, there were revealed that the inorganic particle disperses evenly, coagulation of the inorganic particle is suppressed, coloration is suppressed, the transparency of the blue ray is improved, and the thermal expansion is suppressed.

The optical element related to the present invention is preferred that the optical transparency of light having wavelength of 405 nm is not less than 70% at the thickness of 3 mm. In case the optical transparency is less than 70%, accuracy of data reading is deteriorated. In inorganic particles, the particles do not absorb light are popular though some thermoplastic resins absorb the light a little. In this case, the optical transparency of 405 nm wavelength light can be increased by increasing a percentage of the inorganic particles.

In the present invention, as devices capable of melt-kneading process, sealed type melt-kneading devices such as Lab Blast Mill, Brabender, Banbury Mixer, Kneader, Role or batch type melt-kneading device are quoted. Also, sequential melt-kneading devices such as a single-axis extruder and a double-axis extruder can be used for manufacturing.

In the manufacturing method of the thermoplastic composite material related to the present invention, the thermoplastic resin and the inorganic particle can be kneaded at once or can be kneaded by adding step-by step in installments. In this case, in the melt-kneading devices such as the extruders, a component to be added step-by-step can be added from a middle of a cylinder. Also, in case a component not added in advance except for thermoplastic resin is added and further melt-kneaded, they can be added at once or can be added step-by-step for kneading. The method of adding by installments can be a method where one component is added in several installments, a method where a component is added at once and then a different component is added step-by-step and a method combining the methods thereof.

In the present invention, the inorganic particles can be added in a form of powder or in an aggregation state. Or it can be added in a state of dispersion in liquid. In case of adding in a state of dispersion in liquid, volatilizing is preferred to be carried out after kneading.

In case of adding in a state of dispersion in liquid, it is preferred to disperse the aggregated particles into the primary particles in advance prior to adding. For dispersion, while various dispersion devices can be used, a bead mill is particularly preferred. The bead is made of various kinds of materials and size of it is preferred to be not more than 1 mm. Further, the one having the size of not more than 1 mm and not less than 0.001 mm is preferred.

In the manufacturing method of the thermoplastic composite material related to the present invention, a water absorption coefficient of not more than 0.2% by weight is preferred in a view point that the water absorption coefficient of the thermoplastic resin greatly affects a refraction and its temperature dependency of thermoplastic composite material. By adapting the above mentioned condition to the water absorption coefficient of the thermoplastic resin, in case the thermoplastic is used as an optical material, the change of refraction due to a change of an environment can be within a tolerance. Further the water absorption coefficient is preferred to be not more than 0.1% by weight.

Also, a rate of content of the dispersed inorganic particle is preferred to be not less than 10% by weight and not more than 80% by weight. Because, if the rate of content of the inorganic particle is not less than 10% by weight, a property improving effect by mixing inorganic particle can be exerted, also if it is not more than 80% by weight, a necessary rate of thermoplastic resin can be maintained as well as a favorable characteristic of the thermoplastic such as an inherent merit of workability can not be deteriorated.

The volume-based average dispersed diameter of the inorganic particles dispersed in the thermoplastic resin is preferred to be not more than 300 nm. If the volume-based average dispersed diameter of the inorganic particles is not more than 30 nm, the optical scatter resulting from the inorganic particles can be suppressed and as a result, high optical transparency can be realized.

In case the particles having different diameter distributions are mixed, a mixed particle wherein an average particle size of a particle is not more than 30 nm, an average particle size of another particle is not less than 30 nm and an average of them is 30 nm can be used. In this case, less percentage of the particles having the average particle size of not less than 30 nm is preferred, and in practice, not more than 10% by weight is preferred.

Also, a lower limit of the volume-based average dispersed diameter of the inorganic particles is preferred to be not less than 1 nm, and if it is not less than 1 nm, a specific surface area cannot be too large, thus a processing agent which is required for a surface process to obtain an affinity with the thermoplastic resin can be set in an appropriate range. Therefore in case a shape of the inorganic particles is a spherical shape, if a total volume is equal, a specific surface area is in inverse proportion to an average particle size, for example, if the average particle size is 30 nm to 1 nm, the specific surface area becomes 30 times. Using an inorganic particle of 30 nm, supposing that a required amount of the surface processing agent is 10% of total volume, then in case a particle of 1 nm is used, the amount of surface processing agent becomes 30 time. Therefore, it cannot be realized.

An inert gas which can be used during a melt-kneading process is a kind of gas or a mixed gas where at least two kinds of gases are mixed, chosen from nitrogen, helium, neon, argon, krypton, and xenon. It is so preferable that less contamination of oxygen though it is difficult to eliminate the content of oxygen thoroughly, and less than 1% by volume is especially preferable. Among other general gases, such as carbon dioxide gas, ethylene, hydrogen gas, in case of a gas not having reactivity in respect to the thermoplastic composite material during kneading, the gas can be used mixing with inert gases at an arbitrary mixing rate.

Moreover, it is also preferable to remove the gas sticking to the thermoplastic resin and the inorganic particle beforehand. Thus it is preferable that a melt-kneading is carried out after carrying out reduced pressure de-solvent for each component and being filled up with inert gas such as nitrogen. When using an inorganic particle as dispersion liquid for a kneading, it is preferable to remove dissolved oxygen in advance.

Next, each structural element of the thermoplastic composite material related to the present invention is described in details subsequently.

### [Thermoplastic Resin]

According to the thermoplastic resin related to the present invention, the refractive index of the thermoplastic resin can be controlled adequately by dispersing an inorganic particle in the thermoplastic resin which includes an organic polymer and a temperature dependency is improved.

As the thermoplastic resin, as far as it is a transparent thermoplastic resin generally used as an optical material, the resin is no restriction in particular. However, if the workability as the optical element is taken into consideration, acryl resin, cyclic olefin resin, polycarbonate resin, polyester resin, polyether resin, polyamide resin and polyimide resin are preferred, and cyclic olefin resin is particularly preferred, for example, the compounds cited in JP-A No. 2003-73559 can be cited. The preferable compounds are shown in Table 1.

| Resin | | Refraction | Abbe's |
|---|---|---|---|
| number | Structure | index | number |
| (1) | 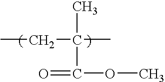 | 1.49 | 58 |
| (2) | 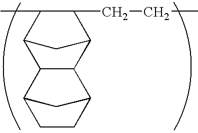 | 1.54 | 56 |
| (3) | 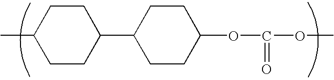 | 1.53 | 57 |
| (4) | 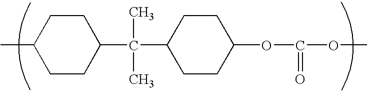 | 1.51 | 58 |
| (5) | 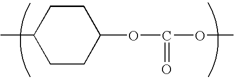 | 1.52 | 57 |
| (6) | 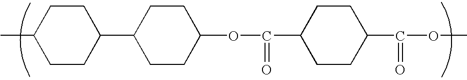 | 1.54 | 55 |
| (7) | 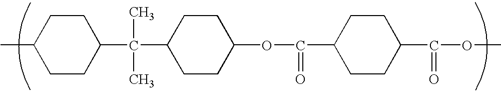 | 1.53 | 57 |
| (8) | 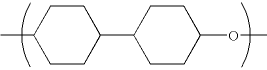 | 1.55 | 57 |
| (9) | 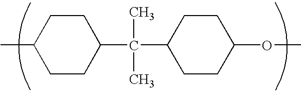 | 1.54 | 57 |
| (10) | 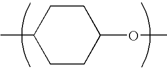 | 1.55 | 58 |
| (11) | 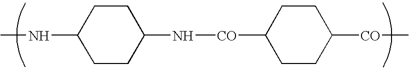 | 1.55 | 53 |
| (12) | 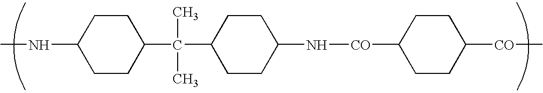 | 1.54 | 55 |
| (13) | 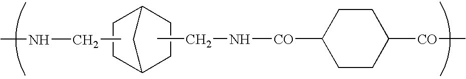 | 1.54 | 56 |
| (14) | 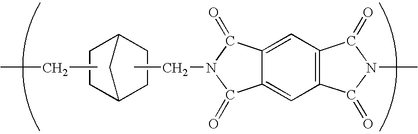 | 1.58 | 43 |

In the thermoplastic resin, it is preferable that the water absorption coefficient is 0.2% by weight or less. As the resin having the water absorption coefficient of 0.2% by weight or less, for example, polyolefin resin (For example, polyethylene, polypropylene etc.), and fluororesins (for example, polytetrafluoroethylene, Teflon (registered trademark), AF (made by Du Pont) cytop (Asahi Class Co., Ltd.), cyclic olefin resin (for example, ZEONEX (made by Nippon Zeon Co., Ltd.), Arton (made by JSR), Appel (made by a Mitsui-Chemicals company), TOPAS (made by Ticona), etc.), indene/styrene resin, and polycarbonate are preferable. However, the resins are not limited thereto. Moreover, it is also preferable to use these resins together with other resins having compatibility. In case two or more kinds of resins are used, the water absorption coefficient is deemed to be almost equal to an average value of the water absorption coefficient of each resin, and the average of the water absorption coefficient should be 0.2% or less.

### [Inorganic Particle]

As for an inorganic particle, it is preferable that the average volume dispersion particle size of the primary particle is 30 nm or less, and not less than 1 nm and not more than 30 nm is more preferable, further not less than 1 nm and not more than 10 nm is yet more preferable. If an average volume dispersion particle size is 1 nm or more, a dispersibility of the inorganic particle can be maintained and a desired performance can be obtained. Also if the average volume dispersion particle size is not more than 30 nm, a preferable clarity of the thermoplastic composite material obtained can be acquired and a light transparency of more than 70% can be achieved. The average volume dispersion particle size mentioned here means a diameter of a sphere having the same volume as the inorganic particle in dispersion condition. Also, even if the particle size of condensed primary particles is 30 nm or more, it is possible to maintain the desired clarity by carrying out deagglomeration of the coagulum and distributing it, however it is difficult to obtain a particle having a particle size of 30 nm or less by pulverizing the primary particle. The size of the primary particle is important. Meanwhile, the size of the primary particle can be confirmed using SEM and TEM, and it can be predicted by measuring a specific surface area by BET.

While the form of the inorganic particle is not limited, spherical particles are preferably used. Moreover, although distribution of a particle size is not limited, in order to bring out the effect of the present invention more efficiently, one having a comparatively narrow distribution is preferably used rather than one having an extensive distribution. Meanwhile, the form of an inorganic particle can be confirmed using SEM and TEM.

As an inorganic particle, for example, an oxide particle is cited. More specifically, for example, silica, titanium oxide, ZNO, aluminum oxide, zirconium oxide, oxidation hafnium, niobium oxide, tantalum oxide, magnesium oxide, calcium oxide, strontium oxide, barium oxide, yttrium oxide, lanthanum oxide, cerium oxide indium oxide, tin oxide, lead oxide, multiple oxides configured with the oxides thereof, lithium niobate, potassium niobate, lithium tantalite or phosphate, and sulfate can be quoted.

Also, the fine particles of a semiconducting crystal composition can also be preferably used as an inorganic particle. While there is no restriction in particular in this semiconducting crystal composition, the inorganic particles which do not cause absorption, photogenesis and fluorescence in the wavelength area used as the optical element are desirable. As a concrete examples of the compositions, for example; the simple substance of the 14th group elements of a periodic table, such as carbon, silicon, germanium, and tin; the simple substance of the 15^{th} group elements of a periodic table, such as phosphorus (black phosphors); the simple substance of the 16th group elements of a periodic table, such as selenium and tellurium; the compound which includes a plurality of 14th group elements of a periodic table, such as silicon carbide (SiC); the compound of the 14th group elements of a periodic table and 16th group element of a periodic table, such as tin oxide (IV) (SnO₂), a tin monosulphide (II, IV) (Sn(II)Sn(IV)S₃), tin monosulphide (IV) (SnS₂), tin monosulphide (II) (SnS), selenium-ized tin (II) (SnSe), tin telluride (II) (SnTe), plumbous sulfide (II) (PbS), lead selenide (II) (PbSe), lead telluride (II) (PbTe); the compound of the 13th group elements of a periodic table, and the 15th group element of a periodic table (or group III-V semiconducter), such as Boron nitride (BN), boron phosphide (BP), boron arsenide (BAs), aluminium nitride (AlN), aluminium phosphide (AlP), aluminum arsenide (AlAs), aluminum antimonide (AlSb), gallium nitride (GaN), gallium phosphide (GaP), gallium arsenide (GaAs), gallium antimonide (GaSb), indium nitride (InN), indium phosphide (InP), indium arsenide (InAs), and indium antimonide (InSb); the compound of the 13th group elements of a periodic table, and the 16th group element of a periodic table, such as aluminum sulfate (Al₂S₃), aluminum selenade (Al₂Se₃), sulfuration gallium (Ga₂S₃), gallium selenade (Ga₂Se₃), gallium telluride (Ga₂Te₃), indium oxide (In₂O₃) sulfuration indium (In₂S₃), indium serenade (In₂Se₃), indium telluride (In₂Te₃); the compound of the 13th group elements of a periodic table, and the 17th group element of a periodic table such as thallium(I) chloride (TlCl), thallium bromide (I) (TlBr), iodination thallium (I) (TlI); the compound of the 12th group elements of a periodic table, and the 16th group element of a periodic table (or II-VI group compound semiconductor), such as a ZNO (ZnO), zinc sulfide (ZnS), zinc selenide (ZnSe), zinc telluride (ZnTe), cadmium oxide (CdO), cadmium sulfide (CdS), cadmium selenate (CdSe), cadmium telluride (CdTe), a mercury sulfide (HgS), mercury selenide (HgSe), and mercury telluride (HgTe); the compound of the 15th group elements of a periodic table, and the 16th group element of a periodic table, such as arsenic sulfide (III) (As₂S₃), arsenic selenide (III) (As₂Se₃), arsenic telluride (III) (As₂Te₃), antimony sulfide (III) (Sb₂S₃), antimony selenide (III) (Sb₂Se₃), antimony telluride (III) (Sb₂Te₃), and bismuth telluride (III) (Bi₂Te₃), Bismuth sulfide (III) (Bi₂S₃), bismuth selenide(III) (Bi₂Se₃); the compound of the 11th group elements of a periodic table and the 16th group element of a periodic table, such as copper(I) oxide (Cu₂O) and copper selenide (I) (Cu₂Se); the compound of the 11th group elements of a periodic table, and the 17th group element of a periodic table, copper(I) chloride (CuCl), copper bromide (I) (CuBr), copper iodide (I) (CuI), silver chloride (AgCl) and a silver bromide (AgBr); the compound of the 10th group elements of a periodic table and the 16th group elements of a periodic table such as nickel oxide (II) (NiO); the compound of the 9th group elements of a periodic table and 16th group element of a periodic table, such as cobalt oxide (II) (CoO), and cobalt sulfide (II) (CoS); the compound of periodic table octavus group elements and the 16th group element of a periodic table, triiron tetraoxide (Fe₃O₄) and iron sulfide (II) (FeS); the compound of the 7th group elements of a periodic table, and 16th group element of a periodic table such as manganese oxide (II) (MnO); the compound of the 6th group elements of a periodic table, and the 16th group element of a periodic table; such as molybdenum sulfide (IV) (MoS₂) and tungstic oxide (IV) (WO₂); the compound of the 5th group elements of a periodic table and the 16th group element of a periodic table, such as vanadium oxide (II) (VO), vanadium oxide (IV) (VO2) and tantalum pentoxide (Ta₂O₅); the compound of the 4th group elements of a periodic table, and the 16th group element of a periodic table, such as a titanium oxide (TiO₂, Ti₂O₅, Ti₂O₃, Ti₅O₉ grade); the compound of the 2nd group elements of a periodic table, and the 16th group element of a periodic table such as sulfuration magnesium (MgS) and magnesium selenade (MgSe); chalcogen spinel, such as cadmium oxide (II) chromium (III) (CdCr₂O₄), cadmium selenate (II) chromium (III) (CdCr₂Se₄), copper sulfide (II) chromium (III) (CuCr₂S₄) and mercury selenide (II) chromium (III) (HgCr₂Se₄); and barium titanate (BaTiO₃) are quoted. In addition, a semiconductor cluster whose structure is confirmed such as (BN)₇₅(BF₂)₁₅F₁₅ reported by G. Schmid; Adv. Mater., in the fourth volumes on page 494 page (1991), and Cu₁₄₆Se₇₃(triethyl phosphine)₂₂ reported by D. Fenske; Angew. Chem. Int. Ed. Engl., in the 29th volume, on page 1452 (1990) are exemplified as well.

The refractive index of an inorganic particle, is preferable to be 1.2-3.0 in 588 nm and more preferable to be 1.3 to 2.2 and yet more preferable 1.4 to 1.7. The more the refractive index of an inorganic particle becomes close to that of a resin, the more the problem of light scattering is not likely caused because the resins having the refractive index 1.4 to 1.7 are popular. This is not a case for a resin having a high refractive index, however, it is preferable that a refractive index difference is less than 0.3 and more preferably, it is less than 0.2.

For these inorganic particles, one kind of inorganic particle may be used or two or more kinds of inorganic particles can be used together. Also, it is possible to use the inorganic particle having a compound composition.

### [The Production Method and Surface Modification of an Inorganic Particle]

The manufacturing method of an inorganic particle is not limited in particular, and any publicly known method can be used for it. For example, desired oxide particles can be obtained by hydrolyzing in the reaction system containing water using a halogenation metal and an alkoxy metal as a raw material. In this case, the method of using an organic acid and organic amine together for stabilization of particles is also used. More substantially, for example, in case of titanium dioxide particles, a publicly know method disclosed in journal of Chemical Engineering of Japan the 31^{st} volume pave 21-28 (1998) and in case of zinc sulfide, a publicly known method disclosed in journal of Physical Chemistry 100^{th} volume page 468 to 471 (1996) can be used. For example, following these methods, the titanium oxide whose volume average dispersion particle size is 5 nm can be easily manufactured by adding a suitable surface modification agent using a titanium tetraisopropoxide and titanium tetrachloride as a raw material, when hydrolyzing is carried out in a suitable solvent. Also, zinc sulfide whose volume average dispersion particle size is 40 nm can be manufactured by adding a surface modification agent when sulfurating with hydrogen sulfide or sodium sulfide using dimethyl zinc and zinc chloride as a raw material. The method of surface modification is not limited thereto in particular, and any publicly known method can be used. For example, a method to modify the surface of particles by hydrolysis under a condition in which water exists is cited. In this method, the catalyser such as an acid or an alkali is used and it is generally thought that a hydroxyl group on a surface of the particles and a hydroxyl grope produced by hydrolyzing of a surface modification agent are dehydrated to form binding.

As available surface modification agents, for example, a silane coupling agent: tetramethoxysilane, tetraethoxysilane, tetraisopropoxysilane, tetraphenoxysilane, methyltrimethoxysilane, ethyltrimethoxysilane, propyl trimethoxysilane, methyltriethoxysilane, methyl tri phenoxy silane, ethyltriethoxysilane, phenyltrirmethoxsilane, 3-methylphenyl trimethoxysilane, dimethyl dimethoxy silane, diethyl diethox silane, diphenyl dimethoxy silane, diphenyl diphenoxy silane, trimethyl methoxy silane, triethyl ethoxy silane, triphenyl methoxy silane, triphenyl phenoxy silane, etc. are cited.

Also, a titanium coupling agent: Tetra-butyl titanate, tyetra-octyl titanate, isopropyltriisostearoyl titanate, isopropyltri decyl benzene sulfonyl titanate, bis(dioctyl pyro phosphate) oxyacetate titanate, are cited.

In addition, it is also possible to use an aluminate series coupling agent, an amino acid system dispersing agent, and various silicone oils for surface processing.

These surface modification agents differ in characteristics, such as a reaction rate, and a compound suitable for the requirements of surface modification can be used for them. Also, a plurality of kinds can be used together or one kind can be used. Furthermore, a quality of the surface modification particles obtained can be affected by the compound used. To obtain a thermoplastic composite material, the affinity with the thermoplastic resin used is realized by selecting the compound used for surface modification.

Although the rate of a surface modification agent is not limited in particular, it is preferable that the rate of a surface modification agent is 10-99% by weight in respect to the particles after surface modification, and it is 30-98% by weight is more preferable.

The thermoplastic composite material related to the present invention is an excellent material in the optical characteristic, where the refractive index is controlled, the temperature dependency of a refractive index is small and the light transparency is high. Further, it is excellent in molding workability since it has a thermoplastic characteristic or injection-molding characteristic. The thermoplastic composite materials having this outstanding optical property and molding workability had not been able to be attained with the material disclosed so far and it is deemed that a composition of a specific thermoplastic resin and a specific inorganic particle contributes to these characteristics.

### [Other Compounding Ingredients]

In the preparation process and molding manufacturing process of the thermoplastic composite material related to the present invention, various addition agent (it is also called a compounding ingredient) can be added if needed. While there is no restriction in particular about the addition agent; a stabilizer such as an antioxidant, a thermostabilizer, a light stabilizer-proof, a weathering stabilizer, a UV absorber, and a near infrared absorber; a resin deactivator such as a lubricant and a porosity agent; white turbidity inhibitor such as soft polymers and an alcohol nature compound; colorants such as dye and a pigment; an antistatic additive, a flame retarder, and a filler are cited. These compounding agents can be used independently, or can be used combining two or more kinds, and the blending quantity is suitably chosen in the extent in which the effect of the present invention is not spoiled. In the present invention, it is preferable that the polymer contains at least a porosity agent or an antioxidant in particular.

### (Porosity Agent)

Although there is no restriction in particular, as the porosity agent, phosphate system porosity agent, phthalate ester plasticizer, a trimellitate system porosity agent, a pyromellitic acid series porosity agent, a glycolate series porosity agent, a citrate plasticizer, a polyester plasticizer, etc. can be cited.

In a phosphate series porosity agent, for example, triphenyl phosphate, tricresyl phosphate, cresyl diphenyl phosphate, octyl diphenyl phosphate, diphenyl biphenyl phosphate, trioctyl phosphate and tributyl phosphate; in a phthalate ester plasticizer, for example, diethyl phthalate, dimethoxy ethyl phthalate, dimethyl phthalate, dioctyl phthalate, dibutyl phthalate, di-2-ethylhexyl phthalate, butyl benzyl phthalate, diphenyl phthalate and dicyclohexyl phthalate; in a trimellitic acid system porosity agent, tributyl trimellitate, triphenyl trimellitate and triethyl trimellitate; in pyromellitic acid plasticizing ester, for example, tetra-butyl pyromeritate, tetra-phenyl pyromeritate and tetra-ethyl pyromeritate; in glycolate siries porosity agent, for example, triacetin, the tributyrin, ethyl phthalyl ethyl glycolate, methyl phthalyl ethyl glycolate and butyl phthalyl butyl glycolate; in a citrate plasticizer ester, for example, triethyl citrate, tri-n-butyl citrate, acetyl triethyl citrate, acetyl tri-n-butyl citrate and acetyl tri-n-(2-ethylhexyl) citrate can be cited. Furthermore, when coloring caused by handling in high temperature needs to be prevented, it is also preferable to use hyper-pure amide wax or fatty acid ester. For example, amide, such as ethylene bis octadecanamide, erucic acid, and oleic acid; monoester, such as methyl laurate, butyl stearate, and behenic acid behenil; polyol ester such as neopentyl polyol long-chain-fatty-acid ester, and di penta erythritol long-chain-fatty-acid ester, are preferable to use.

Also, for the thermoplastic composite material related to the present invention, a compound having a lowest glass transition temperature of 30 degrees C. or less may be blended. By blending the compound thereof, white turbidity under an ambient of prolonged high-temperature and high humidity can be prevented without deteriorating characteristics, such as a clarity, heat resistance, and mechanical strength.

### (Antioxidant)

As an antioxidant, a phenolic antioxidant, a phosphorus system antioxidant, a sulfur series antioxidant are cited.

Among them phenolic antioxidant, and especially alkylation phenolic antioxidant are preferable. By blending these antioxidants, the coloring of a photographic lens and strength reduction due to the oxidation degradation at the time of a molding can be prevented without deteriorating the clarity, the heat resistance.

Although these antioxidants can be used independent, or can be used together combining two or more kinds and the blending quantity is suitably chosen in the extent in which the object of the present invention is not spoiled, and to 100 parts by weight of thermoplastic composite materials of the present invention, 0.001-20 parts by weight is preferably and 0.01-10 parts by weight is more referable.

As a phenolic antioxidant, publicly know compounds can be used. For example, acrylate series compound disclosed in Unexamined Japanese Patent Application Publication No. 63-179953s and No. 1-168643s, such as 2-t-butyl 6-(3-t-butyl 2-hydroxy 5-methylbenzyl)-4-methylphenyl acrylate, 2, and 4-di-t-amyl 6-(1-3,5-di-t-amyl 2 hydroxyphenyl ethyl phenyl acrylate; alkylation phenol series compound such as octadecyl 3-(3-5-di-t-butyl 4 hydroxyphenyl propionate, 2, and 2′-methylene bis(4-methyl 6-t-butyl phenol), 1,1,3-tris(2-methyl 4-hydroxy 5-t-butylphenyl)butane, 1,3, the 5-trimethyls 2 and 4,6-tris(3,5-di-t-butyl 4-hydroxybenzyl) benzene, tetrakis(methylene 3-(3′,5′-di-t-butyl 4′ hydroxyphenyl propionate))methane [namely, pentaerythrymethyl tetrakis(3-(3,5-di-t-butyl 4 hydroxyphenyl propionate))], and the triethylene glycol bis (3-(3-t-butyl 4-hydroxy 5-methylphenyl)propionate); phenol system compound such as 6-(4-hydroxy 3,5-di-t-butyl anilino)-2,4-bis octylthio 1 and 3, and 5-triazine 4-bis octylthio 1 and 3,5-triazine, 2-octylthio 4,6-bis-(3,5-di-t-butyl 4-oxyanilino)-1,3, and 5-triazine are cited.

As a phosphorus series antioxidant there will be no restriction as far as it is a resin usually used in the general resin industry. For example, Mono-phosphite series compound such as triphenyl phosphite, diphenylisodecyl phosphite,

Phenyldiisodecyl phosphite, a tris(nonylphenyl)phosphite, a tris(dinonylphenyl)phosphite, a tris(2,4-di-t-butylphenyl)phosphite, 10-(3 and 5-di-t-butyl 4-hydroxybenzyl)-9 and 10-dihydro9-oxa 10-phospha phenanthrene 10-oxide; di phosphate series compounds, such as a 4′-butylidene bis(3-methyl 6-t-butylphenyl di-tridecyl phosphite),a 4 and 4′-isopropylidene bis(Feni Lod'z alkyl (C12-C15) phosphite) are cited. Also in these, a mono-phosphite series compound is preferable and tris (nonylphenyl)phosphite, tris(dinonylphenyl)phosphite, and tris(2,4-di-t-butylphenyl)phosphite are especially preferable.

As a sulfur system antioxidant, for example, di-lauryl 3,3-thiodi propionate, the di-myristyl 3,3′-thiodi propiopropinate,

The di-stearyl compound 3,3-thiodi propionate, the lauryl stearyl 3,3-thiodi propionate,
Pentaerythritol tetrakis(beta-lauryl thio-propionate), 3, and 9-bis(2-dodecyl thio ethyl)-2, 4 and 8, and 10-tetra-oxa spiro[5,5]undecane are cited.

### (Light Stabilizer-Proof)

As light stabilizer-proof, while light stabilizer-proof [benzophenone system], light stabilizer-proof [benzotriazole system], light stabilizer-proof [hindered amine system] are cited, in the present invention, light stabilizer-proof [hindered amine series] (HALS) is preferable to be used from viewpoints of the clarity of a photographic lens and tinting-proof. As practical examples of HALS, one having low molecular weight, one having intermediate molecular weight and one having high molecular can be chosen.

For example, as the one having small molecular weight, LA-77 (product made from the Asahi electrification), Tinuvin765 (product made from CSC), Tinuvin123 (product made from CSC), Tinuvin440 (product made from CSC), Tinuvin144 (product made from CSC), and middle/of HostavinN20 (made by Hoechst A.G.); as the one having intermediate molecular weight LA-57 (product made from the Asahi electrification), LA-52 (product made from the Asahi electrification), LA-67 (product made from the Asahi electrification), and LA-62 (product made from the Asahi electrification); and the one having larger molecular weight LA-68 (product made from the Asahi electrification), LA-63 (product made from the Asahi electrification), HostavinN30 (made by Hoechst A.G.), Chimassorb944 (product made from CSC), Chimassorb2020 (product made from CSC), Chimassorb119 (product made from CSC), Tinuvin622 (product made from CSC), CyasorbUV-3346 (product made from Cytec), CyasorbUV-3529 (product made from Cytec) and Uvasil299 (product made from GLC) are cited. In molding the thermoplastic composite material in the shape of bulk especially, HALS having low and intermediate molecular weight is preferably used and in molding the thermoplastic composite material in the shape of film, HALS having intermediate and high molecular weight are preferably used.

The above-mentioned blending quantity of the thermoplastic composite material related to the present invention, 0.01-20 parts by weight are preferably and 0.02-15 parts by weight is more preferable and 0.05-10 parts by weight is still more preferably for 100 parts by weight of polymers. If the amount of addition is too small, the improvement effect for a light resistance will not fully be acquired and coloring will be caused when it is used for a long time out door.

On the other hand, if HALS is blended in excessive quantity, the portion evaporates as gas, or the dispersibility to thermoplastic resin is deteriorated, thereby the clarity of a photographic lens is deteriorated.

Next, a production method of the optical element produced from the above mentioned thermoplastic composite material of the present invention is described.

First, the thermoplastic composite material (there are a case where a mixture of a thermoplastic composite material and an addition agent is used, and other case where only a thermoplastic composite material is used) is prepared, and the optical element related to the present invention is molded and formed.

The molding product of a thermoplastic composite material is obtained by molding the thermoplastic composite material. While the molding method is not limited in particular, a melting molding is preferable in order to obtain the molding product superior in characteristics, such as low birefringence, mechanical strength, and dimensional accuracy. As a melting molding method, for example, commercially available press molding, a commercially available extrusion molding, a commercially available injection molding are cited and an injection molding is preferable from a viewpoint of moldability and manufacturing efficiency.

Molding conditions are suitably chosen by application purposes or the molding method, for example, the temperature of the thermoplastic composite material (there are a case of the mixture of a thermoplastic composite material and an addition agent and other case of thermoplastic composite material only) for an injection molding is preferably in a rage of 150 degrees C.-400 degrees C. and more preferably 200 degrees C.-350 degrees C. and yet more preferably 200 degrees C.-330 degrees C. from a view where shrinkage and distortion of a cast are prevented by giving a fluidity to a thermoplastic composite material at the time of a molding, occurrence of silver streak by the pyrolysis of a thermoplastic composite material is prevented and yellowing of the molding is effectively prevented.

Molded products can be used in various forms such as a globular shape, a bar shape, plate shape, column shape, a cylindrical shape, a tabular shape, tube shape, fibrous form film, or a sheet form, and is superior in low birefringence, clarity, mechanical strength, heat resistance, and a low water absorption property.

Therefore, the optical element related to the present invention can be conveniently used as a optical resin lens, and can be conveniently used also as other optical parts.

### (Optical Element)

The optical element related to the present invention is obtained by the above-mentioned production method, and practical examples of application for optical pats are as follows.

For example, as an optical lens or an optical prism; an imaging system photographic lens of a camera; a lens for microscope, inner scope and a telescope; all the ray of light transmission type lens such as a lens for glasses; a pickup lens for an optical disk such as a CD, a CD-ROM, a WORM (write-once read-many optical disc), and a MO (writing and changing possible optical disc; magneto-optical disk); a laser scanning system photographic lenses such as a f θ photographic lens of laser beam printer and a sensor lens; and a prism photographic lens of a finder system of a camera are cited.

As an optical disc application, compact disc, CD-ROM, WORM (write-once read-many optical disc), MO (writing and changing possible optical disc; magneto-optical disk), MD (mini disk), digital versatile disk (digital videodisc) are cited. As other optical applications, a light guide plate such as a liquid crystal display; optical film such as a polarization film, a phase difference film and a light diffusing film; light diffusion plate; light card; and liquid crystal display element substrates, are cited.

Among them, it is suitable for the pickup lens to which low birefringence is demanded, and a laser scanning system photographic lens, and is used most suitably for a pickup lens.

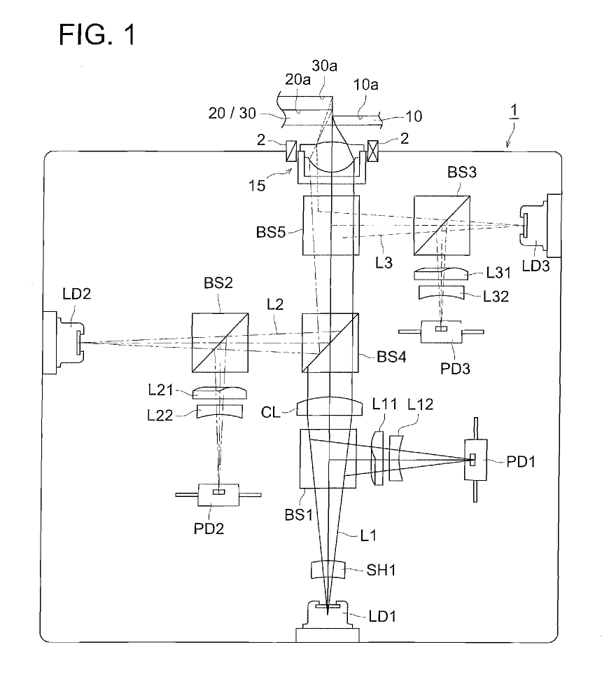

Here, referring to FIG. 1, as an application example of optical element related to the present invention, an embodiment where the present optical element is applied for an optical pickup device for optical discs is described.

FIG. 1 is a cross-sectional view showing a schematic configuration of the optical pickup device 1.

The optical pickup device 1 has 3 kinds of semiconductor laser oscillator LD1 LD2, and LD3 as light sources, as shown in FIG. 1. Semiconductor laser oscillator LD1 emits a bundle of rays having a specified wavelength (for example, 405 nm, 407 nm) in a wavelength of 350-450 nm for BD (or AOD) 10. Semiconductor laser oscillator LD2 emits a ray bundle having a specified wavelength in a wavelength of 620-680 nm for digital versatile disk 20. Semiconductor laser LD3 emits a bundle of rays having a specified wavelength in 750-810 nm for compact disc 30.

In the direction of an optical axis of the light (blue light) emitted from semiconductor laser, oscillator LD1 Shaver SH1, splitter BS1, collimator CL, Splitter BS4, BS5, and the objective lens 15 are arranged in order from a lower part towards an upper pats in FIG. 1, and BD10, digital versatile disk 20, or compact disc 30 is disposed as an optical information recording medium in a position opposite to the objective lens 15. Cylindrical lens L11, concave lens L12, and photo-detector PD1 are disposed in order on the right in FIG. 1 of the splitter BS1.

Splitter BS2 and BS4 are disposed in the direction of an optical axis of the light (red light) emitted from semiconductor laser oscillator LD2 in order from the left to the right in FIG. 1. Cylindrical lens L21, concave lens L22, and photo-detector PD2 are arranged on a lower side of splitter BS2 in FIG. 1.

Splitter BS3 and BS5 are arranged in the direction of an optical axis of the light emitted from semiconductor laser oscillator LD3 in order from the right to the left in FIG. 1. Cylindrical lens L31, concave lens L32, and photo-detector PD3 are disposed on a lower side of splitter BS3 in FIG. 1.

Objective lens 15 to be disposed opposite to BD10, digital versatile disk 20, or compact disc 30 which are optical information recording media, has a function to converge the light emitted from each semiconductor laser oscillator LD1, LD2, and LD3 to BD10. Two-dimensional actuator 2 is allocated to the objective lens 15, objective lens 15 is configure to be able to move in a vertical direction by operation of the aforesaid two-dimensional actuator 2.

The job and action in the optical pickup device 1 are described briefly. At the time of recording of the information on BD10, or reproduction of the information in BD10, first, semiconductor laser oscillator LD1 emits a light. The light becomes ray of light L1 shown by a solid line in FIG. 1, and goes through shaper SH1 to be shaped, then the light goes through splitter BS1, and is formed into a collimated light by collimator CL, and then goes through each splitter BS4, BS5, and the objective lens 15, thus the light forms a condensing spot on the recording surface 10a of BD10.

The light forming a condensing spot is modulated by information pit on the recording surface 10a of BD10 and reflected by the recording surface 10a. The reflected light goes through objective lens 15, splitter BS5 and collimator CL, and reflected by splitter BS1, then goes through a cylindrical lens L11 where a stigmatism is given. Then the light goes through a concave lens 12 and is received by photo-detector PD1. Thereby, recording of the information on BD10 and reproduction of the information in BD10 are performed.

At the time of recording of the information on digital versatile disk 20, and reproduction of the information in digital versatile disk 20, semiconductor laser oscillator LD2 emits a light. The light becomes ray of light L2 shown by broken lines in FIG. 1, and goes through splitter BS2, then is reflected by splitter BS4, and then goes through splitter BS5 and the objective lens 15. Then the light forms a condensing spot on recording surface 20a of digital versatile disk 20.

The light forming the condensing spot is modulated by information pit on the recording surface 20a of DVD 20 and reflected by the recording surface 20a. The reflected light goes through objective lens 15 and splitter BS5 and is reflected by each splitter BS4 and BS2 then goes through cylindrical lens 21 where an astigmatism is given. Then the light goes through a concave lens 22 and is received by photo-detector PD2. Thereby, recording of the information on DVD 20 and reproduction of the information in DVD 20 are performed.

At the time of recording of the information on CD 30, and reproduction of the information in CD 30, semiconductor laser oscillator LD3 emits a light.

The light becomes ray of light L3 shown by broken lines in FIG. 1, and goes through splitter BS3, then is reflects by splitter BS5, and then goes through the objective lens 15, and forms a condensing spot on recording surface 30a of CD 30.

The light forming the condensing spot is modulated by information pit on the recording surface 30a of CD 30 and reflected by the recording surface 30a. The reflected light goes through objective lens 15 and is reflected by each splitter BS5 and BS3 then goes through cylindrical lens 31 where an astigmatism is given. The light goes through a concave lens 32 and is received by photo-detector PD3. Thereby, recording of the information on CD 30 and reproduction of the information in CD 30 are performed.

Meanwhile, at the time of recording of the information on BD10, digital versatile disk 20, or compact disc 30, and reproduction of the information in BD10, digital versatile disk 20, or compact disc 30, the optical pickup device 1 detects change of the quantity of light caused by change of the shape and change of the position of the spot on each photo-detector PD1, PD2, and PD3, and performs focusing detection and track detection.

And the aforesaid optical pickup device 1 moves the objective lens 15 so that the two-dimensional actuator 2 carry out image formation of the light from semiconductor laser oscillator LD1, LD2, and LD3 on the recording surfaces 10a and 20a of BD10, based on the detection result of each photo-detector PD1, PD2, and PD3, and further move objective lens 15 so that the light from semiconductor laser oscillator LD1, LD2, and LD3 forms an image on a prescribed truck of each recording surfaces 10a, 20a, and 30a.

In the above optical pickup device 1, the optical elements related to the present invention are applied to shaver SH1, splitters BS1-BS5, collimator CL, the objective lens 15, a cylindrical lens L11, L21, L31, the concave lens L12, L22, and L32, and these members are composed of above-mentioned thermoplastic composite materials.

### Embodiment 1

Hereinafter, embodiments of the present invention will be concretely described without the present invention being restricted thereto:

### (1.1) Production of a Specimen

As knead apparatus, Toyo Seiki Seisaku-Sho Ltd. Lab Plast μ was equipped with Segment Mixer KF6. Then the following thermoplastic resin 1 and the following inorganic particles 1-4 were supplied to the mixer and kneading was performed at 200 degrees C. for 10 minutes, thus the kneaded materials 1-8 were produced.

Various kinds of gas in Table 2 were supplied to inside the system through a sample inlet port during the kneading to suppress air contamination.

Thermoplastic resin 1: Zeonex 330R (cycloolefin resin product of Nippon Zeon Co., Ltd.) was desiccated at 80 degrees C., before kneading. The refractive index of resin 1 was 1.52. Inorganic-particle 1: RX300 (Product of Japanese Aerosil, silica powder grain having a primary particle size of 7 nm and a refractive index 1.46) was desiccated at 200 degrees C. before kneading then kept under the nitrogen atmosphere to be used.

Inorganic particle 2: Alumina C (Product of Japanese Aerosil, Alumina powder grain having a primary particle size of 13 nm and a refractive index 1.69) was desiccated at 200 degrees C. before kneading and then kept under the nitrogen atmosphere to be used.
Inorganic-particle 3: OX50 (Product of Japanese Aerosil Company, silica powder grain having a primary particle size of 40 nm, a refractive index 1.46) was desiccated for 24 hours at 200 degrees C. before kneading and kept under the nitrogen atmosphere to be used.
Inorganic particle 4: Zirconium oxide (Product of Sumitomo Osaka Cement having a primary particle size of 3 nm, and a refractive index 2.19) was desiccated for 24 hours at 200 degrees C. before kneading then surface processing by hexamethyldisilazane was carried out and kept under the nitrogen atmosphere to be used.

The kneaded materials 1-8 produced as mentioned above were molded respectively into discs having 10 mm in a diameter and 3 mm in a thickness, whose surfaces are formed into a mirror surface, thereby specimens 1-8 were produced.

### (1.2) Evaluation of a Specimen

For each specimen produced as mentioned above, evaluation of light transmission and a coefficient of thermal expansion were performed according to the following method.

### (1.2.1) Measurement of Light Transparency

A light transparency (%) was measured using TURBIDITY METER T-2600DA made by the Tokyo Denshoku Co., Ltd. through a method based on ASTM D1003,

### (1.2.2) Evaluation of a Coefficient of Thermal Expansion

The coefficient of linear expansion was measured using TMA/SS6100 of Seiko Instruments, and the rate of change of thermoplastic resin 1 of the simple substance specimen was calculated.

The results obtained by the above are shown in Table 2.

TABLE 2

| | | Amount of | | | 405 nm | Change of | |
|---|---|---|---|---|---|---|---|
| | | organic | Resin | | optical | linier | |
| | Organic | particle | additional | Kneading | transparency | expansion | |
| Specimen | particle | (g) | agent (g) | atmosphere | (%) | coefficient | Remarks |
| 1 | 1 | 1.0 | 3.0 | Nitrogen | 75 | −20% | Present |
| | 2 | 6.0 | | | | | invention |
| 2 | 1 | 1.0 | 3.0 | Air | 26 | −20% | Comparative |
| | 2 | 6.0 | | | | | example |
| 3 | 3 | 4.0 | 3.0 | Nitrogen | 50 | −15% | Comparative |
| | | | | | | | example |
| 4 | 1 | 1.0 | 3.0 | Argon | 78 | −20% | Present |
| | 2 | 6.0 | | | | | invention |
| 5 | 1 | 0.2 | 4.9 | Nitrogen | 86 | −2% | Present |
| | | | | | | | invention |
| 6 | 1 | 0.2 | 4.9 | Air | 30 | −2% | Comparative |
| | | | | | | | example |
| 7 | 4 | 12.0 | 3.0 | Nitrogen | 71 | −28% | Present |
| | | | | | | | invention |
| 8 | 4 | 12.0 | 3.0 | Air | 15 | −27% | Comparative |
| | | | | | | | example |

As the results cited in table 2 clarifies, the specimens 1, 4, 5, and 7 of the present invention manufactured in the manufacturing process of the present invention have a high optical transparency compared to the specimens 2, 3, 6, and 8 of comparative examples, and its thermal expansion is suppressed.

### Embodiment 2

### Production of (2.1) Specimens

Instead of Laboratory Plast mill used in production of the specimens 1-8 of Embodiment 1, using the S1KRC kneader (made by Kurimoto), the kneaded material 9-11 was produced using the following thermoplastic resin 2 and the inorganic particle 5, and specimens 9-11 were produced in the same method as the one described in the Embodiment 1. Meanwhile, the supplied amount of energy for kneading was obtained in a range where extrusion speed becomes constant while the thermoplastic resin 2 and the inorganic particle 5 were added regularly. Adjustment of energy amount supplied was performed also by rearranging the segment of a screw besides changing temperature and revolution speed.

Thermoplastic resin 2: Acry pet VH (a product of Mitsubishi Rayon Co., Ltd., acryl resin)

Inorganic particle 5: HM-30S (silica particle made by Tokuyama Corp. primary particle size of 7 nm).

Meanwhile, as an inorganic particle 5, an inorganic particle in which HM-30S was dispersed in THF by a beads mill (Ultra APEX Mill made by Kotobuki Industry, 0.05 mm bead) was used.

The dispersed diameter of a particle material of the inorganic particle 5 is measured by Master Sizer of Malvern Ltd. and an average particle size of 7 nm and D90 particle size of 10 nm or less were confirmed. After the inorganic particle 5 is adjusted into a slurry having 40% by weight, it was mulled with the thermoplastic resin 2.

Furthermore, An addition agent: elegant N-1100 by Nippon Oil & Fats Corporation was added during kneading to obtain the following weight ratio.

Thermoplastic resin 2/addition agent 1=99/1

### (2.2) Evaluation of Specimens

Subsequently, for each specimen produced in the above, the optical transparency and the coefficient of thermal expansion were evaluated in the same method as described in the embodiment 1. The results obtained are shown in table 3.

TABLE 3

| | | | 405 nm | | |
|---|---|---|---|---|---|
| | Weight percent | | optical | Change of linier | |
| | of inorganic | Kneading | transparency | expansion | |
| Specimen | particle (%) | atmosphere | (%) | coefficient | Remarks |
| 9 | 40 | Argon | 85 | −30% | Present |
| | | | | | invention |
| 10 | 40 | Air | 62 | −28% | Comparative |
| | | | | | example |
| 11 | 5 | Argon | 76 | −3% | Present |
| | | | | | invention |

As the results cited in table 3 clarifies, the specimens 9 and 11 manufactured in the process of the present invention using a dual shaft extruder, have a high optical transparency compared to the specimen 10 of comparative examples, and its thermal expansion is suppressed.

### Embodiment 3

Using the above kneaded materials 1-11, plastic optical elements 1 to 11 (the numeral of the ending portion of “optical element 1-11” are related to the kneaded material 1-11.) were produced and evaluated. As the results, it was confirmed that optical elements 1, 4, 5, 7, 9 and 11 has a preferable optical properties and is superior in material deterioration resistance such as white turbidity when they are irradiated by blue-ray used for recording and reproduction of compact disc or digital versatile disk.

1. A manufacturing method of a thermoplastic composite material, comprising steps of:
melt-kneading a thermoplastic resin and an inorganic particles whose volume-average primary particle size is 30 nm or less,
wherein the melt-kneading process are carried out under an inert gas atmosphere.

2. The manufacturing method of a thermoplastic composite material of claim 1, wherein the inert gas is a gas selected from nitrogen, helium, neon, argon, krypton, and xenon or a mixed gas in which at least two gases are selected form the gases thereof.

3. The manufacturing method of a thermoplastic composite material of claim 1, wherein a rate of content of the inorganic particle is not less than 10% by weight and not more than 80% by weight.

4. The manufacturing method of a thermoplastic composite material of claim 1, wherein the thermoplastic resin includes at least a cycloolefin resin.

5. A thermoplastic composite material manufactured by the manufacturing method of claim 1.

6. An optical element is made from the thermoplastic composite material of claim 5.

7. A thermoplastic composite material, comprising:
a thermoplastic resin and organic particles whose volume average dispersion particle size of a primary particle is 30 nm or less,
wherein an optical transparency is 70% or more at 405 nm in a thickness of 3 mm.

8. An optical element made from the thermoplastic composite material of claim 7.
